(19) United States
(12) Patent Application Publication
(10) Pub. No.: US 2019/0103231 A1
(43) Pub. Date: Apr. 4, 2019

(54) INTERNAL HYBRID ELECTROCHEMICAL ENERGY STORAGE CELL

(71) Applicant: Nanotek Instruments, Inc., Dayton, OH (US)

(72) Inventors: Songhai Chai, Centerville, OH (US); Aruna Zhamu, Springboro, OH (US); Bor Z. Jang, Centerville, OH (US)

(73) Assignee: Nanotek Instruments, Inc., Dayton, OH (US)

(21) Appl. No.: 15/722,497

(22) Filed: Oct. 2, 2017

(51) Int. Cl. H01G 11/06; H01M 12/00; H01M 10/0525; H01G 11/86; H01G 11/08; H01G 11/50; H01M 4/13; C01B 32/182

(52) U.S. Cl. CPC H01G 11/06; H01M 12/005; H01M 10/0525; C01B 32/182; H01G 11/08; H01G 11/50; H01M 4/13; H01G 11/86

(57) ABSTRACT

Provided is an internal hybrid electrochemical cell comprising: (A) a pseudocapacitance cathode comprising both graphene sheets and a 2D inorganic material, in a form of nanodiscs, nanoplatelets, or nanosheets that are bonded to or supported by primary surfaces (not the edges) of the graphene sheets and the 2D inorganic material and graphene sheets form a redox pair for pseudocapacitance; (B) a battery-like anode comprising a prelithiated anode active material (e.g. prelithiated Si, SiO, Sn, SnO₂, etc.), and (C) a lithium-containing electrolyte in physical contact with the anode and the cathode; wherein the cathode active material has a specific surface area no less than 100 m²/g which is in direct physical contact with the electrolyte.

### FIELD OF THE INVENTION

This invention relates generally to the field of electrochemical energy storage devices and, more particularly, to a totally new internal hybrid battery/pseudocapacitor cell featuring a battery-like anode and a pseudocapacitor-like cathode.

### BACKGROUND OF THE INVENTION

### Supercapacitors (Ultra-Capacitors or Electro-Chemical Capacitors):

A supercapacitor normally depends on porous carbon electrodes to create a large surface area conducive to the formation of diffuse electric double layer (EDL) charges. The ionic species (cations and anions) in the EDL zones are formed in the electrolyte near an electrode surface when voltage is imposed upon a symmetric supercapacitor (or EDLC). The required ions for this EDL mechanism pre-exist in the liquid electrolyte (randomly distributed in the electrolyte) when the cell is made or in a discharged state.

When the supercapacitor is re-charged, the ions (both cations and anions) already pre-existing in the liquid electrolyte are formed into EDLs near their respective local electrodes. There is no exchange of ions between an anode active material and a cathode active material. The amount of charges that can be stored (capacitance) is dictated solely by the concentrations of cations and anions that pre-exist in the electrolyte. These concentrations are typically very low and are limited by the solubility of a salt in a solvent, resulting in a low energy density.

Since the formation of EDLs does not involve a chemical reaction or an exchange of ions between the two opposite electrodes, the charge or discharge process of an EDL supercapacitor can be very fast, typically in seconds, resulting in a very high power density (more typically 3,000-8,000 W/Kg). Compared with batteries, supercapacitors offer a higher power density, require no maintenance, offer a much higher cycle-life, require a very simple charging circuit, and are generally much safer. Physical, rather than chemical, energy storage is the key reason for their safe operation and extraordinarily high cycle-life.

Another type of supercapacitor is a pseudocapacitor that stores electrical energy by means of reversible faradaic redox reactions on the surface of suitable carbon electrodes. Such an electrode typically is composed of a carbon material (e.g. activated carbon) and a transition metal oxide (or a conjugate polymer), which together form a redox pair. Pseudocapacitance is typically accompanied with an electron charge-transfer between electrolyte and electrode arising from a de-solvated and adsorbed ion whereby only one electron per charge unit participates. This faradaic charge transfer originates from a very fast sequence of reversible redox, intercalation or electrosorption processes. The adsorbed ion has no chemical reaction with the atoms of the electrode (no chemical bonding) since only a charge-transfer occurs.

Despite the positive attributes of supercapacitors, there are several technological barriers to widespread implementation of supercapacitors for various industrial applications. For instance, EDLC supercapacitors possess very low energy densities when compared to batteries (e.g., 5-8 Wh/kg for commercial supercapacitors vs. 20-40 Wh/Kg for the lead acid battery and 50-100 Wh/kg for the NiMH battery). Although a pseudocapacitor can exhibit a higher specific capacitance or energy density relative to the EDLC, the energy density per cell is typically lower than 20 Wh/kg. The conventional pseudocapacitor also suffers from a poor cycle life. Lithium-ion batteries possess a much higher energy density, typically in the range of 150-220 Wh/kg, based on the total cell weight.

### Lithium-Ion Batteries (LIB):

Although possessing a much higher energy density, lithium-ion batteries deliver a very low power density (typically 100-500 W/Kg), requiring typically hours for re-charge. Conventional lithium-ion batteries also pose some safety concern.

The low power density or long re-charge time of a lithium ion battery is due to the mechanism of shuttling lithium ions between the interior of an anode and the interior of a cathode. During recharge, lithium atoms must diffuse out of a cathode active material (e.g. particles of LiCoO₂), migrate through an electrolyte phase, and enters or intercalates into the bulk of an anode active material particles (e.g. graphite particles). Most of these lithium ions have to come all the way from the cathode side by diffusing out of the bulk of a cathode active particle, through the pores of a solid separator (pores being filled with a liquid electrolyte), and into the bulk of a graphite particle at the anode.

During discharge, lithium ions diffuse out of the anode active material (e.g. de-intercalate out of graphite particles 10 μm in diameter), migrate through the liquid electrolyte phase, and then diffuse into the bulk of complex cathode crystals (e.g. intercalate into particles lithium cobalt oxide, lithium iron phosphate, or other lithium insertion compound). Because the liquid electrolyte only reaches the external surface (not interior) of a solid particle (e.g. graphite particle), lithium ions swimming in the liquid electrolyte can only migrate (via fast liquid-state diffusion) to the surface of a graphite particle. To penetrate into the bulk of a solid graphite particle would require a slow solid-state diffusion (commonly referred to as “intercalation”) of lithium ions. The diffusion coefficients of lithium in solid particles of lithium metal oxide are relatively low; e.g. typically 10⁻¹⁶-10⁻⁸ cm²/sec (more typically 10⁻¹⁴-10⁻¹⁰ cm²/sec), although those of lithium in liquid are approximately 10⁻⁶ cm²/sec.

As such, these intercalation or solid-state diffusion processes require a long time to accomplish because solid-state diffusion (or diffusion inside a solid) is difficult and slow. This is why, for instance, the current lithium-ion battery for plug-in hybrid vehicles requires 2-7 hours of recharge time, as opposed to just seconds for supercapacitors. The above discussion suggests that an energy storage device that is capable of storing as much energy as in a battery and yet can be fully recharged in one or two minutes like a supercapacitor would be considered a revolutionary advancement in energy storage technology.

### Lithium Ion Capacitors (LIC):

A hybrid energy storage device that is developed for the purpose of combining some features of an EDL supercapacitor (or symmetric supercapacitor) and those of a lithium-ion battery (LIB) is a lithium-ion capacitor (LIC). A LIC contains a lithium intercalation compound (e.g., graphite particles) as an anode and an EDL capacitor-type cathode (e.g. activated carbon, AC). In a commonly used LIC, LiPF₆ is used as an electrolyte salt, which is dissolved in a solvent, such as propylene carbonate. When the LIC is in a charged state, lithium ions are retained in the interior of the lithium intercalation compound anode (i.e. micron-scaled graphite particles) and their counter-ions (e.g. negatively charged PF₆⁻) are disposed near activated carbon surfaces.

When the LIC is discharged, lithium ions migrate out from the interior of graphite particles (a slow solid-state diffusion process) to enter the electrolyte phase and, concurrently, the counter-ions PF₆⁻ are also released from the EDL zone, moving further away from AC surfaces into the bulk of the electrolyte. In other words, both the cations (Li⁺ ions) and the anions (PF₆⁻) are randomly disposed in the liquid electrolyte, not associated with any electrode. This implies that the amounts of both the cations and the anions that dictate the specific capacitance of a LIC are essentially limited by the solubility limit of the lithium salt in a solvent (i.e. limited by the amount of LiPF₆ that can be dissolved in the solvent) and the surface area of activated carbon in the cathode. Therefore, the energy density of LICs (a maximum of 14 Wh/kg) is not much higher than that (6 Wh/kg) of an EDLC (symmetric supercapacitor), and remains an order of magnitude lower than that (most typically 150-220 Wh/kg) of a LIB.

Furthermore, due to the need to undergo de-intercalation and intercalation at the anode, the power density of a LIC is not high (typically <12 kW/kg, which is comparable to or only slightly higher than those of an EDLC).

The above review of the prior art indicates that a battery has a higher energy density, but is incapable of delivering a high power (high currents or pulsed power) that an EV, HEV, or micro-EV needs for start-stop and accelerating. A battery alone is also not capable of capturing and storing the braking energy of a vehicle. A supercapacitor or LIC can deliver a higher power, but does not store much energy (the stored energy only lasts for a short duration of operating time) and, hence, cannot be a single power source alone to meet the energy/power needs of an EV or HEV. Thus, there is an urgent need for an electrochemical energy storage device that delivers both a high energy density and a high power density.

### SUMMARY OF THE INVENTION

The present invention provides an internal hybrid electrochemical cell comprising:
(A) a pseudocapacitance cathode comprising a cathode active material that contains both graphene sheets and a 2D inorganic material, in a form of nanodiscs, nanoplatelets, or nanosheets, selected from: (a) bismuth selenide or bismuth telluride, (b) transition metal oxide, dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof; wherein the nanodiscs, platelets, or sheets, having a thickness less than 10 nm, are bonded to or supported by primary surfaces (not the edge faces) of the graphene sheets and the 2D inorganic material and the graphene sheets, when intimately contacted together, form a redox pair for pseudocapacitance;
(B) a battery-like anode comprising a prelithiated anode active material selected from the group consisting of (a) lithiated silicon (Si), germanium (Ge), tin (Sn), lead (Pb), antimony (Sb), bismuth (Bi), zinc (Zn), aluminum (Al), titanium (Ti), cobalt (Co), nickel (Ni), manganese (Mn), cadmium (Cd), and mixtures thereof; (b) lithiated alloys or intermetallic compounds of Si, Ge, Sn, Pb, Sb, Bi, Zn, Al, Ti, Co, Ni, Mn, Cd, and their mixtures; (c) lithiated oxides, carbides, nitrides, sulfides, phosphides, selenides, tellurides, or antimonides of Si, Ge, Sn, Pb, Sb, Bi, Zn, Al, Fe, Ti, Co, Ni, Mn, Cd, and mixtures or composites thereof; and (d) combinations thereof; and
(C) a lithium-containing electrolyte in physical contact with the anode and the cathode; wherein the cathode active material has a specific surface area no less than 100 m²/g (preferably >500 m²/g, more preferably >700 m²/g, and most preferably >1000 m²/g) which is in direct physical contact with the electrolyte. There can be a porous separator disposed between the anode and the cathode.

It may be noted that there is no lithium metal (i.e. no lithium metal foil, particle, chip, etc.) present in the anode. The lithium atoms reside in the interior of the prelithiated particles of the anode active material before the anode (along with a cathode, separator and electrolyte) is assembled into the electrochemical cell. Bare lithium metal is highly reactive with oxygen and moisture in the air, which is not conducive to cell fabrication. More significantly, lithium metal in an electrochemical cell tends to develop metal surface powdering, dead lithium particles (being separated from Li foil), and dendrite (hence, internal shorting). Surprisingly, the instant approach of prelithiating anode active material particles has effectively eliminated these issues.

The 2D inorganic material nanodiscs, nanoplatelets, or nanosheets each has two primary surfaces (large length and width or large disc diameter, typically from 10 nm to 10 μm) separated by an ultra-thin thickness (0.5 nm to 10 nm). The aspect ratio (length-to-thickness or largest dimension-to-thickness ratio) of the 2D inorganic material herein of interest is typically from 10 to 10,000. The graphene sheets, a 2D carbon-based material, also have an ultra-high aspect ratio. As such, the contact area between a 2D inorganic material (nanodisc, sheet, or platelet) and a graphene sheet is huge, as large as a primary surface area of a 2D inorganic material. Such a face-to-face or primary surface-to-primary surface contact enables fast and massive electron charge transfer between the two members (graphene and 2D inorganic material) of a redox pair, leading to unexpectedly high pseudocapacitance.

Preferably, the nanodiscs, nanoplatelets, or nanosheets contain a single-layer disc, platelet, or sheet of the 2D inorganic material; i.e. there is only one atomic or molecular plane of constituent atoms (e.g. on average, 1 Mn atom is bonded to 2 O atoms to form a MnO₂ molecule or compound on the same molecular plane).

In certain embodiments, the graphene sheets comprise single-layer or few-layer graphene, containing up to 10 graphene planes. By definition, a few-layer graphene sheet contains 2-10 planes of hexagonal carbon atoms (“graphene planes”) stacked together via van der Waals forces. Graphene sheets may be selected from pristine graphene, graphene oxide, reduced graphene oxide, halogenated graphene, hydrogenated graphene, nitrogenated graphene, doped graphene, chemically functionalized graphene, or a combination thereof.

In some embodiments, the 2D inorganic material has 1-10 atomic or molecular planes and graphene sheets contain mostly single-layer (1 graphene plane) and few layer graphene (2-10 graphene planes).

In certain preferred embodiments, the 2D inorganic material in the cathode of the cell is selected from V₂O₅, V₆O₁₃, LiV₃O₈, MnO₂, CoO₂, NiO₂, MoO₃, MoS₂, TaS₂, ZrS₂, WS₂, or a combination thereof. In some embodiments, the inorganic material is selected from an oxide, sulfide, selenide, or telluride of niobium, zirconium, molybdenum, hafnium, tantalum, tungsten, titanium, cobalt, manganese, iron, nickel, zinc, copper, tin, other transition metal, or a combination thereof.

Preferably, the cathode active material has a specific surface area no less than 200 m²/g which is in direct physical contact with the electrolyte and the 2D inorganic material discs, platelets, or sheets have a thickness less than 20 nm. Further preferably, the cathode active material has a specific surface area no less than 500 m²/g which is in direct physical contact with the electrolyte and the discs, platelets, or sheets have a thickness less than 10 nm (preferably <5 nm and most preferably <2 nm).

Preferably, the cathode active material contains a single-layer boron nitride sheet or single-layer MnO₂ sheet that is bonded to a primary surface (not the edge face) of a graphene sheet. Further preferably, the cathode active material contains a single-layer boron nitride sheet or single-layer MnO₂ sheet that is bonded to a primary surface of a single-layer graphene sheet. In some embodiments, the cathode active material contains a zirconium disulfide nanodisc or molybdenum disulfide nanosheet having a thickness less than 5 nm.

In certain embodiments, the anode active material of the internal hybrid electrochemical cell contains prelithiated particles of Si, Ge, SiO, Sn, SnO₂, or a combination thereof. In some preferred embodiments, the anode active material contains prelithiated particles of Si, Ge, SiO, Sn, SnO₂, or a combination thereof and the cathode active material contains a single-layer boron nitride sheet, single-layer MnO₂ sheet, or single-layer zirconium disulfide nanodisc that is bonded to a primary surface of a graphene sheet. In some embodiments, the cathode active material contains a single-layer or few-layer (up to 10 layers) of boron nitride sheet, MnO₂ nanosheet, zirconium disulfide nanodisc, or molybdenum disulfide nanosheet that is bonded to a primary surface of a single-layer graphene sheet.

In some embodiments, the cathode further contains a conductive additive and the cathode forms a mesoporous structure having a pore size in the range from 2 nm to 50 nm.

The cathode may further contain a resin binder that bonds graphene sheets and the 2D inorganic material discs, platelets, or sheets together. In some embodiments, the cathode further contains a conductive filler selected from graphite or carbon particles, carbon black, expanded graphite, graphene, carbon nanotube, carbon nanofiber, carbon fiber, conductive polymer, or a combination thereof.

In certain embodiments, the internal hybrid electrochemical cell contains an anode current collector to support the anode material and/or a cathode current collector to support the cathode material. Preferably, at least one of the anode and the cathode contains a current collector that is a porous, electrically conductive material selected from metal foam, metal web or screen, perforated metal sheet, metal fiber mat, metal nanowire mat, porous conductive polymer film, conductive polymer nanofiber mat or paper, conductive polymer foam, carbon foam, carbon aerogel, carbon xerogel, graphene foam, graphene oxide foam, reduced graphene oxide foam, carbon fiber paper, graphene paper, graphene oxide paper, reduced graphene oxide paper, carbon nanofiber paper, carbon nanotube paper, or a combination thereof.

In certain preferred embodiments, the anode active material contains prelithiated particles of Si, Ge, SiO, Sn, SnO₂, or a combination thereof and the prelithiated particles reside in pores of a porous, electrically conductive material selected from metal foam, metal web or screen, perforated metal sheet, metal fiber mat, metal nanowire mat, porous conductive polymer film, conductive polymer nanofiber mat or paper, conductive polymer foam, carbon foam, carbon aerogel, carbon xerogel, graphene foam, graphene oxide foam, reduced graphene oxide foam, carbon fiber paper, graphene paper, graphene oxide paper, reduced graphene oxide paper, carbon nanofiber paper, carbon nanotube paper, or a combination thereof.

The electrolyte in the internal hybrid electrochemical cell may be an organic liquid electrolyte, ionic liquid electrolyte, or gel electrolyte containing an amount of lithium ions when the cell is made.

The invention also provides an energy storage device comprising at least two presently invented internal hybrid electrochemical cells that are connected in series or in parallel.

The invention also provides an energy device comprising at least one internal hybrid electrochemical cell herein invented, which is electrically connected to an electrochemical cell (e.g. a battery, a supercapacitor, a fuel cell, etc.) in series or in parallel.

### BRIEF DESCRIPTION OF THE DRAWINGS

FIG. 1 Schematic of an internal hybrid electrochemical energy storage cell composed of a battery-like anode and a pseudocapacitor cathode, according to an embodiment of the present invention.

FIG. 2 Schematic of a process for producing graphene sheets.

FIG. 3 Some representative charge-discharge curve of an internal hybrid cell, featuring a lithiated Si anode and a pseudocapacitance cathode containing MnO₂ nanosheet/bonded graphene sheets.

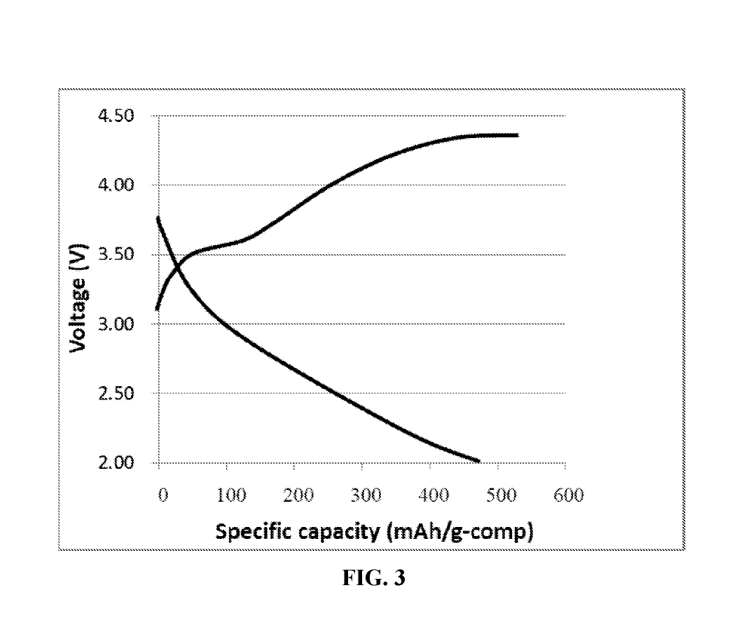

FIG. 4 The charge storage capacity values (based on cathode active material weight) of a series of internal hybrid cells each featuring a lithiated Si anode and a pseudocapacitance cathode containing MnO₂ nanosheet/bonded graphene sheets, and those of the cells containing, in the cathode, MnO₂ only or graphene sheets only as the cathode active material.

FIG. 5 The charge-discharge cycling curve of an internal hybrid cell, featuring a lithiated Si anode and a pseudocapacitance cathode containing MnO₂ nanosheet/bonded graphene sheets

FIG. 6 Ragone plot of three types of electrochemical cells each having prelithiated SiO as the anode active material: a cell using graphene as a cathode active material, a cell using ZrS₂ nanodiscs as the cathode active material, and ZrS₂— bonded graphene sheets as a cathode active material (90% ZrS₂— bonded graphene nanosheets and 10% PVDF as a resin binder).

FIG. 7 Ragone plots of three types of electrochemical cells, each having prelithiated SnO₂ as the anode active material: (i) a cell using graphene as a cathode active material, (ii) a cell using single-layer MoS₂ nanoplatelets as the cathode active material, and (iii) an internal hybrid cell using MoS₂— bonded graphene sheets as a cathode active material.

### DESCRIPTION OF THE PREFERRED EMBODIMENTS

The present invention may be more readily understood by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting the claimed invention.

This invention provides an internal hybrid electrochemical energy storage device that exhibits a power density significantly higher than the power densities of conventional supercapacitors and dramatically higher than those of conventional lithium ion batteries. This device exhibits an energy density comparable to or higher than those of batteries, and significantly higher than those of conventional supercapacitors.

In certain preferred embodiments, the invented internal hybrid electrochemical cell comprises: (A) a pseudocapacitance cathode comprising both graphene sheets and a 2D inorganic material, in a form of nanodiscs, nanoplatelets, or nanosheets that are bonded to or supported by primary surfaces (not the edges) of the graphene sheets and the 2D inorganic material and graphene sheets form a redox pair for pseudocapacitance; (B) a battery-like anode comprising a prelithiated anode active material (e.g. prelithiated Si, SiO, Sn, SnO₂, etc.) and containing no lithium metal, and (C) a lithium-containing electrolyte in physical contact with the anode and the cathode; wherein the cathode active material has a specific surface area no less than 100 m²/g which is in direct physical contact with the electrolyte. The cell is typically and preferably sealed in a protective casing (e.g. inside a pouch or steel cylindrical tube) to prevent exposure to air.

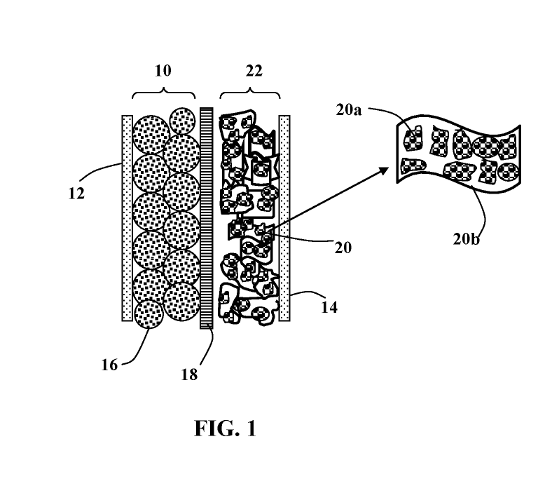

As illustrated in FIG. 1 as an example, the internal hybrid electrochemical cell has an anode active material layer 10 bonded to an anode current collector 12 using a binder resin (not shown). The anode active material layer 10 is composed of multiple prelithiated particles 16 of an anode active material (e.g. prelithiated Si particles each composed of Si that was pre-doped or pre-intercalated with Li atoms prior to cell assembly), optional conductive additive (not shown), and a resin binder (e.g. PVDF, SBR; not shown). There can be two anode active material layers bonded to the two surfaces of an anode current collector (e.g. a Cu foil).

The cell also has a cathode active material layer 22 bonded to a cathode current collector 14 using another binder resin (not shown). The cathode active material layer 22 is composed of multiple two-component sheets (e.g. 20) each containing nanosheets/nanodiscs/nanoplatelets 20a bonded to a primary surface of a graphene sheet 20b. There can be two cathode active material layers bonded to two surfaces of a cathode current collector (e.g. Al foil). A porous separator 18 is disposed between the anode active material layer 10 and the cathode active material layer 22. Both the anode active material layer 10 and cathode active material layer 22 are impregnated with an electrolyte. The cell is then sealed in a protective housing.

A wide range of 2D inorganic materials can be used as a cathode active material. These include those layered materials that can be formed into a thin disc, platelet, or sheet form (having a thickness <100 nm, preferably <10 nm, most preferably <2 nm), exhibiting a high specific surface area In a preferred embodiment, the cathode active material contains nanodiscs, nanoplatelets, or nanosheets of a 2D inorganic material selected from: (a) bismuth selenide or bismuth telluride, (b) transition metal oxide, dichalcogenide, and trichalcogenide (e.g. TiS₃), (c) sulfide, selenide, or telluride of niobium, zirconium, molybdenum, hafnium, tantalum, tungsten, titanium, vanadium, or a transition metal; (d) boron nitride, or (e) a combination thereof; wherein the discs, platelets, or sheets have a thickness less than 100 nm.

Other useful 2D inorganic materials include those from layered transition metal oxides, such as LiCoO₂, V₂O₅, V₆O₁₃, LiV₃O₈, LiNi_{1-y}Co_{y}O₂, LiNi_{y}Mn_{y}Co_{1-2y}O₂, MnO₂, CoO₂, NiO₂, and MoO₃. Many transition metal dichalcogenide, trichalcogenide, sulfide, selenide, or telluride, etc. are also layered materials that can be exfoliated to form nanosheets, platelets, or discs.

One process for producing 2D nanosheets is the ultrasonication-assisted exfoliation of layered inorganic material particles. By dispersing powder of these layered materials (prelithiated or unlithiated) in a low surface tension solvent or water (with a surfactant) and subjecting the resulting suspension to a high-intensity ultrasonicator, one can produce nanoplatelets or sheets of these transition metal oxide materials or their lithiated versions.

Layered-type K_{0.45}MnO₂ may be synthesized by conventional solid-state reactions. For instance, a stoichiometric mixture of K₂CO₃ and Mn₂O₃ may be heated at 800° C. for 30 h under an O₂ gas flow condition to produce the desired K_{0.45}MnO₂.

Another process is based on the direct synthesis strategy. Using the formation of MnO₂ mono-sheets, as an example, one approach involves the preparation of lithium- and sodium-type birnessites by using hydrogen peroxide (H₂O₂) as an oxidizing agent for Mn²⁺ ions. In addition to H₂O₂, one may add tetramethylammonium hydroxide (TMA.OH) in an aqueous solution of manganese(II) chloride (MnCl₂), which readily gives a dark brown suspension in open air at room temperature. The resulting product is colloidal dispersion of MnO₂. Such a suspension may also be obtained if trivalent manganese(III) acetylacetonate (Mn(acac)3) is used instead of divalent MnCl₂, presumably as a reflection of the hydrolysis of Mn(acac)3.

One may then add graphene suspension (e.g. graphene oxide in water) into this colloidal dispersion of MnO₂ to form a slurry. By drying the slurry one obtains hybrid nanosheets wherein mono-layer MnO₂ sheets are bonded to primary surfaces of graphene sheets.

A graphene sheet or nano graphene platelet (NGP) is composed of one basal plane (graphene plane) or multiple basal planes stacked together in the thickness direction. In a graphene plane, carbon atoms occupy a 2-D hexagonal lattice in which carbon atoms are bonded together through strong in-plane covalent bonds. In the c-axis or thickness direction, these graphene planes may be weakly bonded together through van der Waals forces. An NGP can have a platelet thickness from less than 0.34 nm (single layer) to 100 nm (multi-layer). For the present electrode use, the preferred thickness is <10 nm, more preferably <3 nm (or <10 layers), and most preferably single layer graphene. The presently invented graphene-bonded 2D inorganic material preferably contains mostly single-layer graphene, but could make use of some few-layer graphene (less than 10 layers). The graphene sheet may contain a small amount (typically <25% by weight) of non-carbon elements, such as hydrogen, nitrogen, fluorine, and oxygen, which are attached to an edge or surface of the graphene plane.

Graphene sheets (herein also referred to as nano graphene platelets, NGPs) may be produced by using several processes, discussed below:

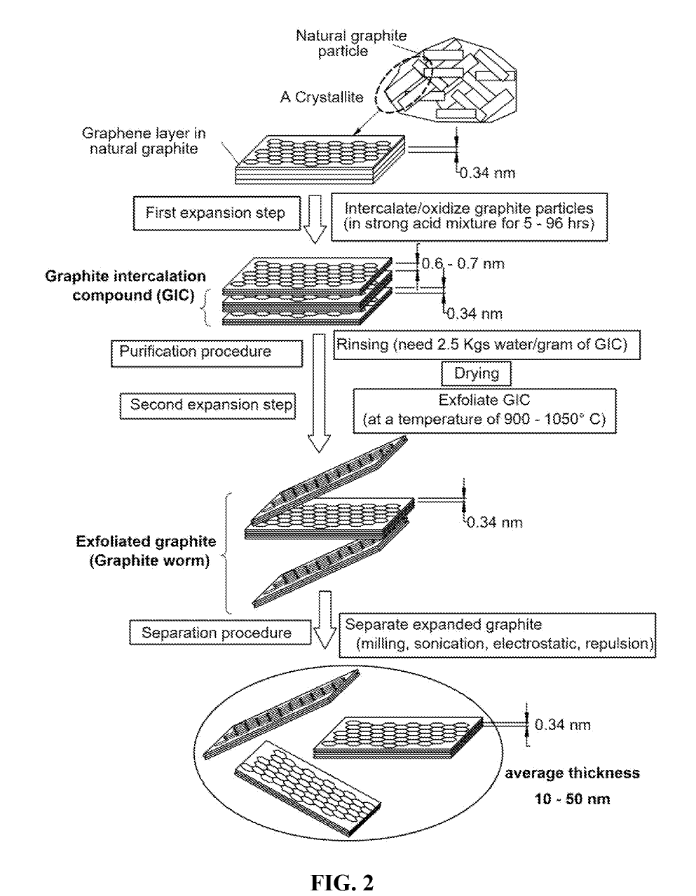

Referring to FIG. 2, graphite oxide may be prepared by dispersing or immersing a laminar graphite material (e.g., powder of natural flake graphite or synthetic graphite) in an oxidizing agent, typically a mixture of an intercalant (e.g., concentrated sulfuric acid) and an oxidant (e.g., nitric acid, hydrogen peroxide, sodium perchlorate, potassium permanganate) at a desired temperature (typically 0-70° C.) for a sufficient length of time (typically 30 minutes to 5 days). In order to reduce the time required to produce a precursor solution or suspension, one may choose to oxidize the graphite to some extent for a shorter period of time (e.g., 30 minutes) to obtain graphite intercalation compound (GIC). The GIC particles are then exposed to a thermal shock, preferably in a temperature range of 600-1,100° C. for typically 15 to 60 seconds to obtain exfoliated graphite or graphite worms, which are optionally (but preferably) subjected to mechanical shearing (e.g. using a mechanical shearing machine or an ultrasonicator) to break up the graphite flakes that constitute a graphite worm. The un-broken graphite worms or individual graphite flakes are then re-dispersed in water, acid, or organic solvent and ultrasonicated to obtain a graphene polymer solution or suspension.

The pristine graphene material is preferably produced by one of the following three processes: (A) Intercalating the graphitic material with a non-oxidizing agent, followed by a thermal or chemical exfoliation treatment in a non-oxidizing environment; (B) Subjecting the graphitic material to a supercritical fluid environment for inter-graphene layer penetration and exfoliation; or (C) Dispersing the graphitic material in a powder form to an aqueous solution containing a surfactant or dispersing agent to obtain a suspension and subjecting the suspension to direct ultrasonication.

In Procedure (A), a particularly preferred step comprises (i) intercalating the graphitic material with a non-oxidizing agent, selected from an alkali metal (e.g., potassium, sodium, lithium, or cesium), alkaline earth metal, or an alloy, mixture, or eutectic of an alkali or alkaline metal; and (ii) a chemical exfoliation treatment (e.g., by immersing potassium-intercalated graphite in ethanol solution).

In Procedure (B), a preferred step comprises immersing the graphitic material to a supercritical fluid, such as carbon dioxide (e.g., at temperature T>31° C. and pressure P>7.4 MPa) and water (e.g., at T>374° C. and P>22.1 MPa), for a period of time sufficient for inter-graphene layer penetration (tentative intercalation). This step is then followed by a sudden de-pressurization to exfoliate individual graphene layers. Other suitable supercritical fluids include methane, ethane, ethylene, hydrogen peroxide, ozone, water oxidation (water containing a high concentration of dissolved oxygen), or a mixture thereof.

In Procedure (C), a preferred step comprises (a) dispersing particles of a graphitic material in a liquid medium containing therein a surfactant or dispersing agent to obtain a suspension or slurry; and (b) exposing the suspension or slurry to ultrasonic waves (a process commonly referred to as ultrasonication) at an energy level for a sufficient length of time to produce the separated nano-scaled platelets, which are pristine, non-oxidized NGPs.

NGPs can be produced with an oxygen content no greater than 25% by weight, preferably below 20% by weight, further preferably below 5%. Typically, the oxygen content is between 5% and 20% by weight. The oxygen content can be determined using chemical elemental analysis and/or X-ray photoelectron spectroscopy (XPS).

The laminar graphite materials used in the prior art processes for the production of the GIC, graphite oxide, and subsequently made exfoliated graphite, flexible graphite sheets, and graphene platelets were, in most cases, natural graphite. However, the starting material may be selected from the group consisting of natural graphite, artificial graphite (e.g., highly oriented pyrolytic graphite, HOPG), graphite oxide, graphite fluoride, graphite fiber, carbon fiber, carbon nanofiber, carbon nanotube, mesophase carbon micro-bead (MCMB) or carbonaceous micro-sphere (CMS), soft carbon, hard carbon, and combinations thereof. All of these materials contain graphite crystallites that are composed of layers of graphene planes stacked or bonded together via van der Waals forces. In natural graphite, multiple stacks of graphene planes, with the graphene plane orientation varying from stack to stack, are clustered together. In carbon fibers, the graphene planes are usually oriented along a preferred direction. Generally speaking, soft carbons are carbonaceous materials obtained from carbonization of liquid-state, aromatic molecules. Their aromatic ring or graphene structures are more or less parallel to one another, enabling further graphitization. Hard carbons are carbonaceous materials obtained from aromatic solid materials (e.g., polymers, such as phenolic resin and polyfurfuryl alcohol). Their graphene structures are relatively randomly oriented and, hence, further graphitization is difficult to achieve even at a temperature higher than 2,500° C. But, graphene sheets do exist in these carbons.

The presently invented process typically resulted in nano graphene sheets that, when formed into a thin film with a thickness no greater than 100 nm, exhibits an electrical conductivity of at least 10 S/cm, often higher than 100 S/cm, and, in many cases, higher than 1,000 S/cm. The resulting NGP powder material typically has a specific surface area from approximately 300 m²/g to 2,600 m²/g and, in many cases, comprises single-layer graphene or few-layer graphene sheets.

When these graphene sheets are combined with a 2D inorganic material to form graphene-2D inorganic hybrid sheets/platelets/discs, these hybrid 2D structures (when packed into a dry electrode) exhibit an electrical conductivity typically no less than 10⁻² S/cm (typically and preferably greater than 1 S/cm and most typically and preferably greater than 100 S/cm; some being greater than 2,000 S/cm). The graphene component is typically in an amount of from 0.5% to 99% by weight (preferably from 1% to 90% by weight and more preferably between 5% and 80%) based on the total weight of graphene and the 2D inorganic material combined.

Graphene sheets may be oxidized to various extents during their preparation, resulting in graphite oxide or graphene oxide (GO). Hence, in the present context, graphene preferably or primarily refers to those graphene sheets containing no or low oxygen content; but, they can include GO of various oxygen contents. Further, graphene may be fluorinated to a controlled extent to obtain graphene fluoride.

The NGPs may be obtained from exfoliation and platelet separation of a natural graphite, synthetic graphite, highly oriented pyrolytic graphite, graphite fiber, carbon fiber, carbon nanofiber, graphitic nanofiber, spherical graphite or graphite globule, mesophase micro-bead, mesophase pitch, graphitic coke, or graphitized polymeric carbon.

For instance, as discussed earlier, the graphene oxide may be obtained by immersing powders or filaments of a starting graphitic material (e.g. natural graphite powder) in an oxidizing liquid medium (e.g. a mixture of sulfuric acid, nitric acid, and potassium permanganate) in a reaction vessel at a desired temperature for a period of time (typically from 0.5 to 96 hours, depending upon the nature of the starting material and the type of oxidizing agent used). The resulting graphite oxide particles may then be subjected to thermal exfoliation or ultrasonic wave-induced exfoliation to produce GO sheets.

Pristine graphene may be produced by direct ultrasonication (also known as liquid phase production) or supercritical fluid exfoliation of graphite particles. These processes are well-known in the art. Multiple pristine graphene sheets may be dispersed in water or other liquid medium with the assistance of a surfactant to form a suspension.

Fluorinated graphene or graphene fluoride is herein used as an example of the halogenated graphene material group. There are two different approaches that have been followed to produce fluorinated graphene: (1) fluorination of pre-synthesized graphene: This approach entails treating graphene prepared by mechanical exfoliation or by CVD growth with fluorinating agent such as XeF₂, or F-based plasmas; (2) Exfoliation of multilayered graphite fluorides: Both mechanical exfoliation and liquid phase exfoliation of graphite fluoride can be readily accomplished [F. Karlicky, et al. “Halogenated Graphenes: Rapidly Growing Family of Graphene Derivatives” ACS Nano, 2013, 7 (8), pp 6434-6464].

Interaction of F₂ with graphite at high temperature leads to covalent graphite fluorides (CF)ₙ or (C₂F)ₙ, while at low temperatures graphite intercalation compounds (GIC) CₓF (2≤x≤24) form. In (CF)ₙ carbon atoms are sp3-hybridized and thus the fluorocarbon layers are corrugated consisting of trans-linked cyclohexane chairs. In (C₂F)ₙ only half of the C atoms are fluorinated and every pair of the adjacent carbon sheets are linked together by covalent C—C bonds. Systematic studies on the fluorination reaction showed that the resulting F/C ratio is largely dependent on the fluorination temperature, the partial pressure of the fluorine in the fluorinating gas, and physical characteristics of the graphite precursor, including the degree of graphitization, particle size, and specific surface area. In addition to fluorine (F₂), other fluorinating agents may be used, although most of the available literature involves fluorination with F₂ gas, sometimes in presence of fluorides.

For exfoliating a layered precursor material to the state of individual layers or few-layers, it is necessary to overcome the attractive forces between adjacent layers and to further stabilize the layers. This may be achieved by either covalent modification of the graphene surface by functional groups or by non-covalent modification using specific solvents, surfactants, polymers, or donor-acceptor aromatic molecules. The process of liquid phase exfoliation includes ultra-sonic treatment of a graphite fluoride in a liquid medium.

The nitrogenation of graphene can be conducted by exposing a graphene material, such as graphene oxide, to ammonia at high temperatures (200-400° C.). Nitrogenated graphene could also be formed at lower temperatures by a hydrothermal method; e.g. by sealing GO and ammonia in an autoclave and then increased the temperature to 150-250° C. Other methods to synthesize nitrogen doped graphene include nitrogen plasma treatment on graphene, arc-discharge between graphite electrodes in the presence of ammonia, ammonolysis of graphene oxide under CVD conditions, and hydrothermal treatment of graphene oxide and urea at different temperatures.

It has been commonly believed that a high specific surface area is an undesirable feature of cathodes (particularly transition metal oxide cathodes) for lithium-ion cells based on the belief that a high surface area leads to the formation of more solid-electrolyte interface (SEI), a common cause of capacity irreversibility or capacity loss. We have herein defied this expectation and discovered that these inorganic cathode materials (when formed into a thin nanodisc, nano platelet, or nanosheet form) can be superior cathode materials for the instant internal hybrid cells, which could operate tens of thousands of cycles without any significant capacity decay. Even more surprisingly, these 2D inorganic nanomaterials, when bonded to graphene sheet surfaces in a face-to-face manner and when the specific surface area of the resulting cathode exceeds 100 m²/g, exhibit a specific capacity significantly higher than that of a corresponding bulk material used as a lithium-ion battery cathode. For instance, the micron-sized layered CoO₂ used in a lithium-ion battery exhibits a specific capacity typically lower than 160 mAh/g. In contrast, the same material produced in a nanoplatelet form bonded to graphene surfaces and used as an internal hybrid cell cathode delivers a specific capacity as high as >365 mAh/g. This is well beyond the expectation of skilled artisans in the field of electrochemistry.

A conductive additive is generally not needed since graphene sheets are conducting even though the inorganic materials (e.g., BN, ZrS₂, etc) are not electrically conducting. However, one may choose to add a conductive additive and/or a binder material (e.g. binder resin or carbonized resin) to form an electrode of structural integrity. The conductive additive or filler may be selected from any electrically conductive material, but is advantageously selected from graphite or carbon particles, carbon black, expanded graphite, graphene, carbon nanotube, carbon nanofiber, carbon fiber, conductive polymer, or a combination thereof. The amount of conductive fillers is preferably no greater than 30% by weight based on the total cathode electrode weight (without counting the cathode current collector weight), preferably no greater than 15% by weight, and most preferably no greater than 10% by weight. The amount of binder material is preferably no greater than 15% by weight, more preferably no greater than 10%, and most preferably no greater than 5% by weight. It is important to note that the inorganic nanomaterials, with or without the conductive filler and binder, must form an electrode having a specific surface area greater than 100 m2/g. The high specific surface area of an inorganic cathode active material per se may not be sufficient; the resulting cathode must form a mesoporous structure having a high specific surface area (>100 m²/g).

The internal hybrid cell contains a negative electrode (including an optional current collector and an anode active material layer) containing a high-capacity active material (e.g. Si, Ge, Sn, SiO, SnO₂, etc.) that is prelithiated before the anode active material layer is made. Preferred electrolyte types include organic liquid electrolyte, gel electrolyte, and ionic liquid electrolyte (preferably containing lithium salts dissolved therein), or a combination thereof, although one may choose to use aqueous or solid electrolytes.

In one preferred embodiment, the anode active material is selected from a lithium intercalation compound, a lithiated compound, lithiated titanium dioxide, lithium titanate, lithium manganate, a lithium transition metal oxide, Li₄Ti₅O₁₂, or a combination thereof. The lithium intercalation compound or lithiated compound may be selected from the following groups of materials: (a) Lithiated silicon (Si), germanium (Ge), tin (Sn), lead (Pb), antimony (Sb), bismuth (Bi), zinc (Zn), aluminum (Al), titanium (Ti), cobalt (Co), nickel (Ni), manganese (Mn), cadmium (Cd), and mixtures thereof; (b) Lithiated alloys or intermetallic compounds of Si, Ge, Sn, Pb, Sb, Bi, Zn, Al, Ti, Co, Ni, Mn, Cd, and their mixtures; (c) Lithiated oxides, carbides, nitrides, sulfides, phosphides, selenides, tellurides, or antimonides of Si, Ge, Sn, Pb, Sb, Bi, Zn, Al, Fe, Co, Ni, Mn, Cd, and mixtures or composites thereof, or (d) Lithiated salts or hydroxides of Sn. There is no lithium metal (e.g. Li foil, Li chips, Li particles, etc.) present in the internal hybrid electrochemical cell.

Prior to prelithiation, particles of the anode active material may be coated with a carbonizable coating material (e.g., phenolic resin, poly(furfuryl alcohol), coal tar pitch, or petroleum pitch). The coating can then be carbonized to produce an amorphous carbon or polymeric carbon coating on the surface of these Si particles. Such a conductive surface coating can help maintain a network of electron-conducting paths during repeated charge/discharge cycles and prevent undesirable chemical reactions between Si and electrolyte from happening. Hence, the presently invented method may further comprise a step of coating a surface of the fine particles with a thin layer of carbon having a thickness less than 1 μm prior to being subjected to lithiating. The thin layer of carbon preferably has a thickness less than 100 nm. Such a thin layer of carbon may be obtained from pyrolization of a polymer, pitch, or organic precursor or obtained by chemical vapor deposition, physical vapor deposition, sputtering, etc.

Alternatively, the particles of an anode active material may be coated with a layer of graphene, electron-conducting polymer, or ion-conducting polymer. Such coating processes are well-known in the art.

Prelithiation can be accomplished in several different ways that can be classified into 3 categories: physical methods, electrochemical methods, and chemical methods. These methods are well-known in the art. Among these, the electrochemical intercalation is the most effective. Lithium ions can be intercalated into non-Li elements (e.g. Si, Ge, and Sn) and compounds (e.g. SnO₂ and Co₃O₄) up to a weight percentage of 54.68% (see Table 1 below). For Zn, Mg, Ag, and Au, the amount of Li can reach 99% by weight.

TABLE 1
Lithium storage capacity of selected non-Li elements.

| Intercalated | Atomic weight | Atomic weight of | Max. wt. % |
|---|---|---|---|
| compound | of Li, g/mole | active material, g/mole | of Li |
| Li₄Si | 6.941 | 28.086 | 49.71 |
| Li_{4.4}Si | 6.941 | 28.086 | 54.68 |
| Li_{4.4}Ge | 6.941 | 72.61 | 30.43 |
| Li4.4Sn | 6.941 | 118.71 | 20.85 |
| Li₃Cd | 6.941 | 112.411 | 14.86 |
| Li₃Sb | 6.941 | 121.76 | 13.93 |
| Li_{4.4}Pb | 6.941 | 207.2 | 13.00 |
| LiZn | 6.941 | 65.39 | 7.45 |
| Li₃Bi | 6.941 | 208.98 | 8.80 |

In the prelithiated particles, the lithium atoms reside in the interior of the anode active material particles before the anode, a cathode, a separator and electrolyte are assembled to become an electrochemical cell. Bare lithium metal is highly reactive with oxygen and moisture in the air, which is not conducive to cell fabrication. Prelithiation of anode active material particles eliminates this shortcoming. More significantly, lithium metal in an electrochemical cell tends to develop metal surface powdering, dead lithium particles (being separated from Li foil), and dendrite (hence, internal shorting). Surprisingly, the instant strategy of using prelithiated anode active material particles effectively eliminates these issues.

The particles of the anode active material may be in the form of a nanoparticle, nanowire, nanofiber, nanotube, nanosheet, nanoplatelet, nanodisc, nanobelt, nanoribbon, or nanohorn. They can be non-lithiated (when incorporated into the anode active material layer) or pre-lithiated to a desired extent (up to the maximum capacity as allowed for a specific element or compound.

In a prior art lithium-ion capacitor (LIC), the primary cathode active material is a carbon material (e.g., activated carbon or CNT bundles), and lithium titanate or lithiated graphite particles constitute the anode. The carbon material in a conventional LIC provides electric double layers of charges. In contrast, the cathode of instant internal hybrid cell is based on graphene-2D inorganic redox pairs that produce pseudocapacitance. Additionally, the anode active material is a prelithiated high-capacity material, such as prelithiated Si, Ge, Sn, SiO, and SnO₂.

A wide range of electrolytes can be used for practicing the instant invention. Most preferred are non-aqueous organic and/or ionic liquid electrolytes. The non-aqueous electrolyte to be employed herein may be produced by dissolving an electrolytic salt in a non-aqueous solvent. Any known non-aqueous solvent which has been employed as a solvent for a lithium secondary battery can be employed. A non-aqueous solvent mainly consisting of a mixed solvent comprising ethylene carbonate (EC) and at least one kind of non-aqueous solvent whose melting point is lower than that of aforementioned ethylene carbonate and whose donor number is 18 or less (hereinafter referred to as a second solvent) may be preferably employed. This non-aqueous solvent is advantageous in that it is (a) stable against a negative electrode containing a carbonaceous material well developed in graphite structure; (b) effective in suppressing the reductive or oxidative decomposition of electrolyte; and (c) high in conductivity. A non-aqueous electrolyte solely composed of ethylene carbonate (EC) is advantageous in that it is relatively stable against decomposition through a reduction by a graphitized carbonaceous material. However, the melting point of EC is relatively high, 39 to 40° C., and the viscosity thereof is relatively high, so that the conductivity thereof is low, thus making EC alone unsuited for use as a secondary battery electrolyte to be operated at room temperature or lower. The second solvent to be used in a mixture with EC functions to make the viscosity of the solvent mixture lower than that of EC alone, thereby promoting the ion conductivity of the mixed solvent. Furthermore, when the second solvent having a donor number of 18 or less (the donor number of ethylene carbonate is 16.4) is employed, the aforementioned ethylene carbonate can be easily and selectively solvated with lithium ion, so that the reduction reaction of the second solvent with the carbonaceous material well developed in graphitization is assumed to be suppressed. Further, when the donor number of the second solvent is controlled to not more than 18, the oxidative decomposition potential to the lithium electrode can be easily increased to 4 V or more, so that it is possible to manufacture a lithium secondary battery of high voltage.

Preferable second solvents are dimethyl carbonate (DMC), methylethyl carbonate (MEC), diethyl carbonate (DEC), ethyl propionate, methyl propionate, propylene carbonate (PC), .gamma.-butyrolactone (gamma-BL), acetonitrile (AN), ethyl acetate (EA), propyl formate (PF), methyl formate (MF), toluene, xylene and methyl acetate (MA). These second solvents may be employed singly or in a combination of two or more. More desirably, this second solvent should be selected from those having a donor number of 16.5 or less. The viscosity of this second solvent should preferably be 28 cps or less at 25° C.

The mixing ratio of the aforementioned ethylene carbonate in the mixed solvent should preferably be 10 to 80% by volume. If the mixing ratio of the ethylene carbonate falls outside this range, the conductivity of the solvent may be lowered or the solvent tends to be more easily decomposed, thereby deteriorating the charge/discharge efficiency. More preferable mixing ratio of the ethylene carbonate is 20 to 75% by volume. When the mixing ratio of ethylene carbonate in a non-aqueous solvent is increased to 20% by volume or more, the solvating effect of ethylene carbonate to lithium ions will be facilitated and the solvent decomposition-inhibiting effect thereof can be improved.

Examples of preferred mixed solvent are a composition comprising EC and MEC; comprising EC, PC and MEC; comprising EC, MEC and DEC; comprising EC, MEC and DMC; and comprising EC, MEC, PC and DEC; with the volume ratio of MEC being controlled within the range of 30 to 80%. By selecting the volume ratio of MEC from the range of 30 to 80%, more preferably 40 to 70%, the conductivity of the solvent can be improved. The electrolytic salts to be incorporated into a non-aqueous electrolyte may be selected from a lithium salt, such as lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃) and bis-trifluoromethyl sulfonylimide lithium [LiN(CF₃SO₂)₂]. Among them, LiPF₆, LiBF₄ and LiN(CF₃SO₂)₂ are preferred. The content of aforementioned electrolytic salts in the non-aqueous solvent is preferably 0.5 to 2.0 mol/1.

The ionic liquid is composed of ions only. Ionic liquids are low melting temperature salts that are in a molten or liquid state when above a desired temperature. For instance, a salt is considered as an ionic liquid if its melting point is below 100° C. If the melting temperature is equal to or lower than room temperature (25° C.), the salt is referred to as a room temperature ionic liquid (RTIL). The IL salts are characterized by weak interactions, due to the combination of a large cation and a charge-delocalized anion. This results in a low tendency to crystallize due to flexibility (anion) and asymmetry (cation).

A typical and well-known ionic liquid is formed by the combination of a 1-ethyl-3-methylimidazolium (EMI) cation and an N,N-bis(trifluoromethane)sulphonamide (TFSI) anion. This combination gives a fluid with an ionic conductivity comparable to many organic electrolyte solutions and a low decomposition propensity and low vapor pressure up to ˜300-400° C. This implies a generally low volatility and non-flammability and, hence, a much safer electrolyte for batteries.

Ionic liquids are basically composed of organic ions that come in an essentially unlimited number of structural variations owing to the preparation ease of a large variety of their components. Thus, various kinds of salts can be used to design the ionic liquid that has the desired properties for a given application. These include, among others, imidazolium, pyrrolidinium and quaternary ammonium salts as cations and bis(trifluoromethanesulphonyl) imide, bis(fluorosulphonyl)imide, and hexafluorophosphate as anions. Based on their compositions, ionic liquids come in different classes that basically include aprotic, protic and zwitterionic types, each one suitable for a specific application.

Common cations of room temperature ionic liquids (RTILs) include, but not limited to, tetraalkylammonium, di-, tri-, and tetra-alkylimidazolium, alkylpyridinium, dialkyl-pyrrolidinium, dialkylpiperidinium, tetraalkylphosphonium, and trialkylsulfonium. Common anions of RTILs include, but not limited to, BF₄⁻, B(CN)₄⁻, CH₃BF₃⁻, CH2CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, C(CN)₃⁻, SCN⁻, SeCN⁻, CuCl₂⁻, AlCl₄⁻, F(HF)_{2.3}⁻, etc. Relatively speaking, the combination of imidazolium- or sulfonium-based cations and complex halide anions such as AlCl₄⁻, BF₄⁻, CF₃CO₂⁻, CF₃SO₃⁻, NTf₂⁻, N(SO₂F)₂⁻, or F(HF)_{2.3}⁻ results in RTILs with good working conductivities.

RTILs can possess archetypical properties such as high intrinsic ionic conductivity, high thermal stability, low volatility, low (practically zero) vapor pressure, non-flammability, the ability to remain liquid at a wide range of temperatures above and below room temperature, high polarity, high viscosity, and wide electrochemical windows. These properties, except for the high viscosity, are desirable attributes when it comes to using an RTIL as an electrolyte ingredient (a salt and/or a solvent) in a supercapacitor.

The following examples serve to illustrate the preferred embodiments of the present invention and should not be construed as limiting the scope of the invention:

### Example 1: Preparation of Isolated Graphene Oxide Sheets, MnO₂ Nanosheets, and Internal Hybrid Cells

Chopped graphite fibers with an average diameter of 12 μm and natural graphite particles were separately used as a starting material, which was immersed in a mixture of concentrated sulfuric acid, nitric acid, and potassium permanganate (as the chemical intercalate and oxidizer) to prepare graphite intercalation compounds (GICs). The starting material was first dried in a vacuum oven for 24 h at 80° C. Then, a mixture of concentrated sulfuric acid, fuming nitric acid, and potassium permanganate (at a weight ratio of 4:1:0.05) was slowly added, under appropriate cooling and stirring, to a three-neck flask containing fiber segments. After 12 hours of reaction, the acid-treated graphite fibers or natural graphite particles were filtered and washed thoroughly with deionized water until the pH level of the solution reached 6. After being dried at 100° C. overnight, the resulting graphite intercalation compound (GIC) or graphite oxide fiber was re-dispersed in water and/or alcohol to form a slurry.

In one sample, five grams of the graphite oxide fibers were mixed with 2,000 ml alcohol solution consisting of alcohol and distilled water with a ratio of 15:85 to obtain a slurry mass. Then, the mixture slurry was subjected to ultrasonic irradiation with a power of 200 W for various lengths of time. After 20 minutes of sonication, GO fibers were effectively exfoliated and separated into thin graphene oxide sheets with oxygen content of approximately 23%-31% by weight. The resulting suspension contains GO sheets being suspended in water.

Single-layer MnO₂ nanosheets bonded on GO sheet surfaces were synthesized through a one-pot procedure. In a typical procedure, 40 mL of mixed aqueous solution prepared from 12 mL of 1.0 M tetramethylammonium hydroxide (TMA-OH), 2 mL of 30 wt % H₂O₂ and 16 mL of distilled water was poured into MnCl₂(aq) (0.3 M, 20 mL) with stirring, and kept stirring for 12 h at 25° C. The obtained reddish-brown MnO₂ suspension was diluted by 140 mL distilled water. A desired amount of GO-water solution obtained earlier was then added to the MnO₂ suspension. The relative amount between the MnO₂ suspension and GO-water solution was varied to give a MnO₂ wt. % in the final hybrid material from 5% to 95%. After stirring, the supernatant became colorless, which indicates the completion of adsorption of MnO₂ nanosheets onto the GO sheet surfaces. The obtained MnO₂/GO hybrid nanosheets were filtered, washed with distilled water until the filtrate became neutral, and then vacuum-dried at 100° C. for 2 days. The GO sheets were thermally reduced at 200° C. for 24 hours to obtain reduced graphene oxide (RGO) sheets that support the MnO₂ sheets for forming redox pairs.

Three types of cells were made, all having lithiated Si particles as the anode active material and 1 M of lithium perchlorate (LiClO₄) in EC-PC (50/50) as the electrolyte. One cell contains RGO sheets (no MnO₂) as the cathode active material. A second cell contains MnO₂ nanosheets as the cathode active material. A third cell contains the MnO₂/RGO hybrid nanosheets as the cathode active material. The conventional slurry coating and drying process was followed to make the cathode electrode. For instance, for the first cell, RGO sheets were mixed with NMP to form a slurry, which was then coated onto both primary surfaces of a sheet of Al foil (serving as a current collector). The cathode contains RGO sheets (88% by wt.), 5% acetylene black as a conductive additive, and 7% PVDF binder resin. The anode (containing lithiated Si nano particles) was also made in a similar manner. An anode and a cathode are spaced by a porous separator to form an electrochemical cell.

### Example 2: Preparation of Single-Layer Graphene Sheets from Meso-Carbon Micro-Beads

Mesocarbon microbeads (MCMBs) were supplied from China Steel Chemical Co., Kaohsiung, Taiwan. This material has a density of about 2.24 g/cm³ with a median particle size of about 16 μm. MCMB (10 grams) were intercalated with an acid solution (sulfuric acid, nitric acid, and potassium permanganate at a ratio of 4:1:0.05) for 48-96 hours. Upon completion of the reaction, the mixture was poured into deionized water and filtered. The intercalated MCMBs were repeatedly washed in a 5% solution of HCl to remove most of the sulphate ions. The sample was then washed repeatedly with deionized water until the pH of the filtrate was no less than 4.5. The slurry was then subjected ultrasonication for 10-100 minutes to produce GO suspensions. TEM and atomic force microscopic studies indicate that most of the GO sheets were single-layer graphene when the oxidation treatment exceeded 72 hours, and 2- or 3-layer graphene when the oxidation time was from 48 to 72 hours.

The GO sheets, in combinations with several different 2D nanosheets/discs, were then made into pseudocapacitor cathodes. Each pseudocapacitor cathode was then paired with a lithiated anode active material layer and a separator/electrolyte to form a cell. Several types of cells, containing different anode and cathode material, were made and tested.

### Example 3: Preparation of Pristine Graphene (0% Oxygen)

Recognizing the possibility of the high defect population in GO sheets acting to reduce the conductivity of individual graphene plane, we decided to study if the use of pristine graphene sheets (non-oxidized and oxygen-free, non-halogenated and halogen-free, etc.) can lead to a graphene supercapacitor having a higher electrical conductivity and lower equivalent series resistance. Pristine graphene sheets were produced by using the direct ultrasonication process (also called the liquid-phase exfoliation process).

In a typical procedure, five grams of graphite flakes, ground to approximately 20 μm or less in sizes, were dispersed in 1,000 mL of deionized water (containing 0.1% by weight of a dispersing agent, Zonyl® FSO from DuPont) to obtain a suspension. An ultrasonic energy level of 85 W (Branson 5450 Ultrasonicator) was used for exfoliation, separation, and size reduction of graphene sheets for a period of 15 minutes to 2 hours. The resulting graphene sheets are pristine graphene that have never been oxidized and are oxygen-free and relatively defect-free. There are essentially no other non-carbon elements. The pristine graphene sheets were then bonded with MoS₂, TaS₂, ZrS₂, and WS₂, respectively, to form pseudocapacitance cathodes.

### Example 4: Preparation of Graphene Oxide (GO) Suspension from Natural Graphite and of Subsequent GO-Supported Inorganic Nanoplatelet Electrodes

Graphite oxide was prepared by oxidation of graphite flakes with an oxidizer liquid consisting of sulfuric acid, sodium nitrate, and potassium permanganate at a ratio of 4:1:0.05 at 30° C. When natural graphite flakes (particle sizes of 14 μm) were immersed and dispersed in the oxidizer mixture liquid for 48 hours, the suspension or slurry appears and remains optically opaque and dark. After 48 hours, the reacting mass was rinsed with water 3 times to adjust the pH value to at least 3.0. A final amount of water was then added to prepare a series of GO-water suspensions using ultrasonication. Some of these GO sheets were then dispersed in a liquid medium, along with a desired type of 2D inorganic material. The resulting suspension containing was then spray-dried to form isolated GO/2D inorganic nanosheets, which were thermally reduced at 150° C. for 12 hours.

### Example 5: Preparation of Porous Graphene Fluoride (GF) Structures

Several processes have been used by us to produce GF, but only one process is herein described as an example. In a typical procedure, highly exfoliated graphite (HEG) was prepared from intercalated compound C₂F.xClF₃. HEG was further fluorinated by vapors of chlorine trifluoride to yield fluorinated highly exfoliated graphite (FHEG). Pre-cooled Teflon reactor was filled with 20-30 mL of liquid pre-cooled ClF₃, the reactor was closed and cooled to liquid nitrogen temperature. Then, no more than 1 g of HEG was put in a container with holes for ClF₃ gas to access and situated inside the reactor. In 7-10 days a gray-beige product with approximate formula C₂F was formed.

Subsequently, a small amount of FHEG (approximately 0.5 mg) was mixed with 20-30 mL of an organic solvent (methanol, ethanol, 1-propanol, 2-propanol, 1-butanol, tert-butanol, isoamyl alcohol) and subjected to an ultrasound treatment (280 W) for 30 min, leading to the formation of homogeneous yellowish dispersions. Five minutes of sonication was enough to obtain a relatively homogenous dispersion, but longer sonication lengths of time ensured better stability. During the sonication procedure, nanosheets of bismuth selenide or bismuth telluride were added for the preparation of the pseudocapacitance cathodes.

### Example 6: Preparation of Nitrogenataed Graphene-Based Supercapacitors

Graphene oxide (GO), synthesized in Example 2, was finely ground with different proportions of urea and the pelletized mixture heated in a microwave reactor (900 W) for 30 s. The product was washed several times with deionized water and vacuum dried. In this method graphene oxide gets simultaneously reduced and doped with nitrogen. The products obtained with graphene/urea mass ratios of 1:0.5, 1:1 and 1:2, respectively and the nitrogen contents of these samples were 14.7, 18.2 and 17.5 wt %, respectively as determined by elemental analysis. These nitrogenataed graphene sheets remain dispersible in water. The resulting suspensions were then added with nanosheets of 2D inorganic materials.

### Example 7: Preparation of MnO₂— Bonded Graphene Sheets

The MnO₂ powder was synthesized in the presence of nitrogenataed graphene. In a typical procedure, a 0.1 mol/L KMnO₄ aqueous solution was prepared by dissolving potassium permanganate in deionized water. Meanwhile 13.3 g surfactant of high purity sodium bis(2-ethylhexyl) sulfosuccinate was added in 300 mL iso-octane (oil) and stirred well to obtain an optically transparent solution. Then, 32.4 mL of 0.1 mol/L KMnO₄ solution were added in the solution, which was followed by dispersing pristine graphene sheets in the solution. The resulting suspension was ultrasonicated for 2 hours and a dark brown precipitate of MnO₂ was coated on surfaces of graphene sheets. The products were recovered, washed several times with distilled water and ethanol, and then spray-dried to form isolated MnO₂-bonded graphene sheets.

### Example 8: Production of Molybdenum Diselenide Nanoplatelets Using Direct Ultrasonication

A sequence of steps can be utilized to form nanoplatelets from many different types of layered compounds: (a) dispersion of a layered compound in a low surface tension solvent or a mixture of water and surfactant, (b) ultrasonication, and (c) an optional mechanical shear treatment.

For instance, dichalcogenides (MoSe₂) consisting of Se—Mo—Se layers held together by weak van der Waals forces can be exfoliated via the direct ultrasonication process invented by our research group [A. Zhamu and Bor Z. Jang, “Method of Producing Nano-scaled Inorganic Platelets,” U.S. Pat. No. 8,308,984 (Nov. 13, 2012)]. Intercalation can be achieved by dispersing MoSe₂ powder in a silicon oil beaker, with the resulting suspension subjected to ultrasonication at 120 W for two hours. The resulting MoSe₂ platelets were found to have a thickness in the range of approximately 1.4 nm to 13.5 nm with most of the platelets being mono-layers or double layers. Graphene sheets were added into the suspension to form a slurry, which was subjected to further ultrasonication for 10-30 minutes. Surprisingly, MoSe₂ platelets were found to get strongly bonded to surfaces of graphene sheets.

Other single-layer platelets of the form MX₂ (transition metal dichalcogenide), including MoS₂, TaS₂, ZrS₂, and WS₂, were similarly exfoliated and separated. Again, most of the platelets were mono-layers or double layers when a level of high sonic wave intensity was utilized for a sufficiently long ultrasonication time, typically >2 hours.

### Example 9: Production of ZrS₂ Nanodisc-Bonded Graphene Sheets

In a representative procedure, zirconium chloride (ZrCl₄) precursor (1.5 mmol) and oleylamine (5.0 g, 18.7 mmol) were added to a 25-mL three-neck round-bottom flask under a protective argon atmosphere. The reaction mixture was first heated to 300° C. at a heating rate of 5° C./min under argon flow and subsequently CS₂ (0.3 mL, 5.0 mmol) and graphene sheets were injected. After 1.5 h, the reaction was stopped and cooled down to room temperature. After addition of excess butanol and hexane mixtures (1:1 by volume), ZrS₂ nanodiscs 22 nm wide and 2 nm thick (˜100 mg) were obtained by centrifugation. Larger sized nanodiscs ZrS₂ of 44 nm and 72 nm in diameter were obtained by changing reaction time to 3 h and 6 h, respectively otherwise under identical conditions.

Pouch cells using ZrS₂— bonded graphene sheets as a cathode active material (90% ZrS₂— bonded graphene nanosheets and 10% PVDF as a resin binder) and lithiated SiO or SnO₂ anode were made and tested. In all cells, the separator used was one sheet of micro-porous membrane (Celgard 2500). The current collector for the cathode was a piece of carbon-coated aluminum foil and that for the anode was Cu foil. The electrolyte solution was 1 M LiPF₆ dissolved in a mixture of ethylene carbonate (EC) and dimethyl carbonate (DMC) with a 3:7 volume ratio. The separator was wetted by a minimum amount of electrolyte to reduce the background current. Cyclic voltammetry and galvanostatic measurements of the lithium cells were conducted using an Arbin 32-channel supercapacitor-battery tester at room temperature (in some cases, at a temperature as low as −40° C. and as high as 60° C.).

### Example 10: Preparation of Boron Nitride Nanosheets

Five grams of boron nitride (BN) powder, ground to approximately 20 μm or less in sizes, were dispersed in a strong polar solvent (dimethyl formamide) to obtain a suspension. An ultrasonic energy level of 85 W (Branson S450 Ultrasonicator) was used for exfoliation, separation, and size reduction for a period of 1-3 hours. This is followed by centrifugation to isolate the BN nanosheets. The BN nanosheets obtained were from 1 nm thick (<3 atomic layers) up to 7 nm thick. Mostly single-layer graphene sheets were used to pair up with BN nanosheets to form a pseudocapacitance cathode.

Coin cells using BN as a cathode active material (75% BN nanosheet-bonded graphene sheets and 10% PVDF as a resin binder) and lithiated Si anode were made and tested. A series of coin cells, Sample BN-1 to BN-7, were made that contain BN-bonded graphene nanosheets of different BN thicknesses, resulting in cathodes of different specific surface areas. In all cells, the separator used was one sheet of micro-porous membrane (Celgard 2500). The current collector for the cathode was a piece of carbon-coated aluminum foil and that for the anode was Cu foil. The electrolyte solution was 1 M LiPF₆ dissolved in a mixture of ethylene carbonate (EC) and dimethyl carbonate (DMC) with a 3:7 volume ratio. The separator was wetted by a minimum amount of electrolyte to reduce the background current. Cyclic voltammetry and galvanostatic measurements of the lithium cells were conducted using an Arbin 32-channel supercapacitor-battery tester.

### Example 11: Details about Evaluation of Various Internal Hybrid Electrochemical Cells

In a conventional cell, an electrode (cathode or anode), is typically composed of 85% of an electrode active material (e.g. graphene, activated carbon, or inorganic nanodiscs, etc.), 5% Super-P (acetylene black-based conductive additive), and 10% PTFE, which were mixed and coated on Al foil. The thickness of electrode is around 100 μm. For each sample, both coin-size and pouch cells were assembled in a glove box. The capacity was measured with galvanostatic experiments using an Arbin SCTS electrochemical testing instrument. Cyclic voltammetry (CV) and electrochemical impedance spectroscopy (EIS) were conducted on an electrochemical workstation (CHI 660 System, USA).

Galvanostatic charge/discharge tests were conducted on the samples to evaluate the electrochemical performance. For the galvanostatic tests, the specific capacity (q) is calculated as

q=I*t/m (1)

where I is the constant current in mA, t is the time in hours, and m is the cathode active material mass in grams. With voltage V, the specific energy (E) is calculated as,

E=∫Vdq (2)

The specific power (P) can be calculated as

P=(E/t)(W/kg) (3)

where t is the total charge or discharge step time in hours.
The specific capacitance (C) of the cell is represented by the slope at each point of the voltage vs. specific capacity plot,

C=dq/dV (4)

For each sample, several current density (representing charge/discharge rates) were imposed to determine the electrochemical responses, allowing for calculations of energy density and power density values required of the construction of a Ragone plot (power density vs. energy density).

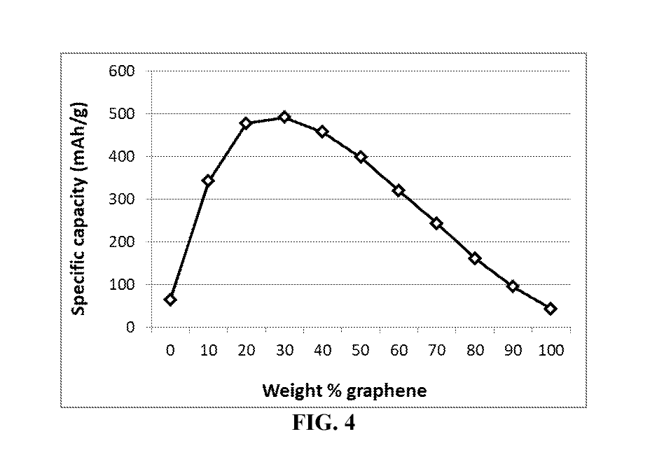

FIG. 4 shows some representative charge-discharge curve of an internal hybrid cell, featuring a lithiated Si anode and a pseudocapacitance cathode containing MnO₂ nanosheet/bonded graphene sheets (prepared in Example 1). The shapes of these curves are characteristic of pseudocapacitance behaviors, rather than electric double layer capacitance (EDLC) or lithium ion-intercalation type battery behavior. The corresponding cyclic voltammetry diagrams further confirm the same behaviors. It may be noted that, in contrast to the conventional lithium-ion capacitor, the instant internal hybrid cell does not have to be limited to an operating voltage from 2.0 V to 4.3 V.

Shown in FIG. 4 are the charge storage capacity values (based on the total cathode active material weight) of a series of internal hybrid cells each featuring a lithiated Si anode and a pseudocapacitance cathode containing MnO₂ nanosheet/bonded graphene sheets, and those of the cells containing, in the cathode, MnO₂ only or graphene sheets only as the cathode active material. These data have clearly exhibited surprising synergistic effects between the nanosheets of a 2D inorganic material and graphene sheets. When implemented alone as a cathode active material, either MnO₂ nanosheets or graphene sheets provide very minimal charge storage capability. When combined to form a redox pair, the two species work together to provide exceptionally high charge storage capacity, up to 480 mAh/g (the sum of MnO₂ weight and graphene weight) between 2.0 V and 4.3 V. This is equivalent to a pseudocapacitance value of >886 F/g, which is among the highest specific capacitance values ever reported.

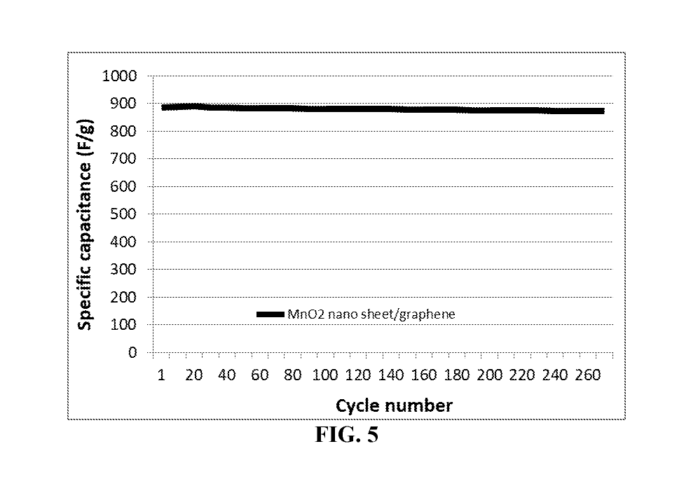

The charge-discharge cycling data of a representative internal hybrid cell are summarized in FIG. 5, which indicates that the internal cell exhibits not only a high specific capacity but also a stable cycling behavior. The cell suffers a capacitance loss of less than 1.5% after 270 cycles, which is outstanding compared to conventional pseudocapacitors or lithium-ion batteries.

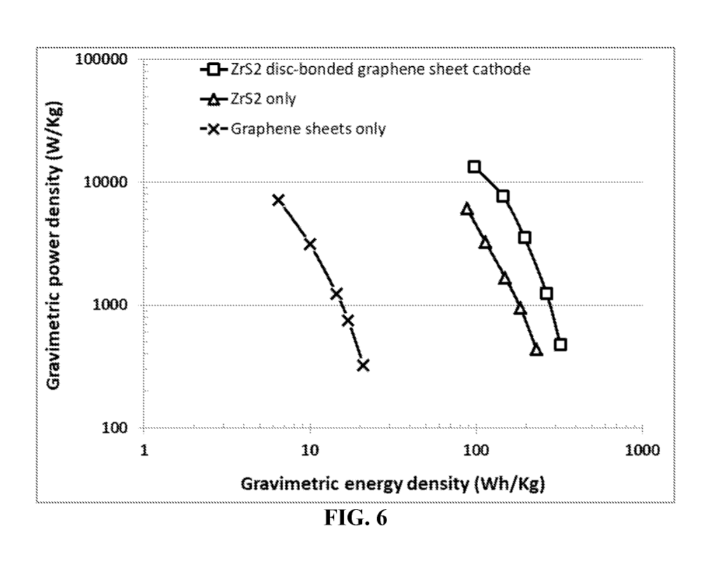

FIG. 6 shows the Ragone plots of three types of electrochemical cells each having a prelithiated SiO as the anode active material: (i) a cell using graphene as a cathode active material, (ii) a cell using ZrS₂ nanodiscs as the cathode active material, and (iii) an internal hybrid cell using ZrS₂— bonded graphene sheets as a cathode active material (90% ZrS₂— bonded graphene nanosheets and 10% PVDF as a resin binder, prepared in Example 9). These results again have demonstrated an unexpected synergistic effect between ZrS₂ nanodiscs (a 2D inorganic nanomaterials) and graphene sheets when the pair of 2D nanomaterialss is implemented as a pseudocapacitance cathode.

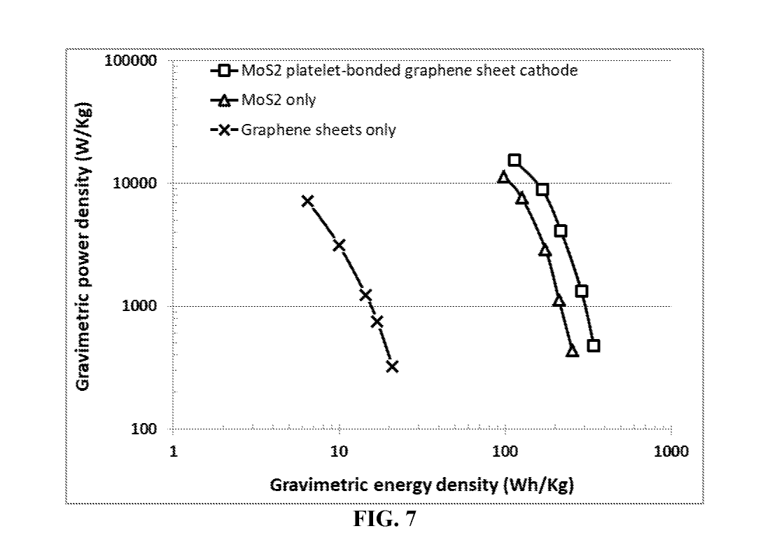

Shown in FIG. 7 are the Ragone plots of three types of electrochemical cells each having a prelithiated SnO₂ as the anode active material: (i) a cell using graphene as a cathode active material, (ii) a cell using MoS₂ nanoplatelets as the cathode active material, and (iii) an internal hybrid cell using MoS₂— bonded graphene sheets as a cathode active material. These results again have demonstrated an unexpected synergistic effect between MoS₂ nanoplatelets (a 2D inorganic nanomaterials) and graphene sheets when this pair of 2D nanomaterials is implemented as a pseudocapacitance cathode. Quite significantly, the energy density of the presently invented internal hybrid cell is as high as 341 Wh/kg, which is significantly higher than those (150-220 Wh/kg) of lithium-ion batteries. A maximum power density of 15.43 kW/kg is dramatically higher than those (typically <0.5 kW/kg) of conventional lithium-ion batteries and even higher than those of supercapacitors. These results have demonstrated that the presently invented internal hybrid electrochemical cells have the best (actually exceed the best) characteristics of both lithium-ion batteries and supercapacitors.

We claim:

1. An internal hybrid electrochemical cell comprising:
(A) a pseudocapacitance cathode comprising a cathode active material that contains both graphene sheets and a 2D inorganic material, in a form of nanodiscs, nanoplatelets, or nanosheets, selected from: (a) bismuth selenide or bismuth telluride, (b) transition metal oxide, dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof; wherein said nanodiscs, platelets, or sheets, having a thickness less than 10 nm, are bonded to or supported by primary surfaces of said graphene sheets and said 2D inorganic material and said graphene sheets form a redox pair for pseudocapacitance;
(B) a battery-like anode comprising a prelithiated anode active material selected from the group consisting of (a) lithiated silicon (Si), germanium (Ge), tin (Sn), lead (Pb), antimony (Sb), bismuth (Bi), zinc (Zn), aluminum (Al), titanium (Ti), cobalt (Co), nickel (Ni), manganese (Mn), cadmium (Cd), and mixtures thereof (b) lithiated alloys or intermetallic compounds of Si, Ge, Sn, Pb, Sb, Bi, Zn, Al, Ti, Co, Ni, Mn, Cd, and their mixtures; (c) lithiated oxides, carbides, nitrides, sulfides, phosphides, selenides, tellurides, or antimonides of Si, Ge, Sn, Pb, Sb, Bi, Zn, Al, Fe, Ti, Co, Ni, Mn, Cd, and mixtures or composites thereof and (d) combinations thereof, and
(C) a lithium-containing electrolyte in physical contact with the anode and the cathode; wherein said cathode active material has a specific surface area from 100 m²/g to 2600 m²/g which is in direct physical contact with said electrolyte.

2. The internal hybrid electrochemical cell of claim 1 wherein said nanodiscs, nanoplatelets, or nanosheets contain a single-layer disc, platelet, or sheet of said 2D inorganic material.

3. The internal hybrid electrochemical cell of claim 1 wherein said graphene sheets comprise single-layer or few-layer graphene, containing up to 10 graphene planes, selected from pristine graphene, graphene oxide, reduced graphene oxide, halogenated graphene, hydrogenated graphene, nitrogenated graphene, doped graphene, chemically functionalized graphene, or a combination thereof.

4. The internal hybrid electrochemical cell of claim 1 wherein said inorganic material is selected from V₂O₅, V₆O₁₃, LiV₃O₈, MnO₂, CoO₂, NiO₂, MoO₃, MoS₂, TaS₂, ZrS₂, WS₂, or a combination thereof.

5. The internal hybrid electrochemical cell of claim 1 wherein said inorganic material is selected from a sulfide, selenide, or telluride of niobium, zirconium, molybdenum, hafnium, tantalum, tungsten, titanium, cobalt, manganese, iron, nickel, zinc, copper, tin, or a combination thereof.

6. The internal hybrid electrochemical cell of claim 1 wherein said cathode active material has a specific surface area from 200 m²/g to 500 m²/g which is in direct physical contact with said electrolyte and said discs, platelets, or sheets have a thickness less than 20 nm.

7. The internal hybrid electrochemical cell of claim 1 wherein said cathode active material has a specific surface area from 500 m²/g to 2600 m²/g which is in direct physical contact with said electrolyte and said discs, platelets, or sheets have a thickness less than 10 nm.

8. The internal hybrid electrochemical cell of claim 1 wherein said cathode active material contains a single-layer boron nitride sheet or single-layer MnO₂ sheet that is bonded to a primary surface of a graphene sheet.

9. The internal hybrid electrochemical cell of claim 1 wherein said cathode active material contains a single-layer boron nitride sheet or single-layer MnO₂ sheet that is bonded to a primary surface of a single-layer graphene sheet.

10. The internal hybrid electrochemical cell of claim 1 wherein said cathode active material contains a zirconium disulfide nanodisc or molybdenum disulfide nanosheet having a thickness less than 5 nm.

11. The internal hybrid electrochemical cell of claim 1 wherein said anode active material contains prelithiated particles of Si, Ge, SiO, Sn, SnO₂, or a combination thereof.

12. The internal hybrid electrochemical cell of claim 1, wherein said anode active material contains prelithiated particles of Si, Ge, SiO, Sn, SnO₂, or a combination thereof and said cathode active material contains a single-layer boron nitride sheet, single-layer MnO₂ sheet, single-layer zirconium disulfide nanodisc, or single-layer molybdenum disulfide sheet that is bonded to a primary surface of a graphene sheet.

13. The internal hybrid electrochemical cell of claim 1, wherein said cathode active material contains a single-layer or few-layer, up to 10 layers, of boron nitride sheet, MnO₂ sheet, zirconium disulfide nanodisc, or molybdenum disulfide nanosheet that is bonded to a primary surface of a single-layer graphene sheet.

14. The internal hybrid electrochemical cell of claim 1 wherein said cathode further contains a conductive additive and said cathode forms a mesoporous structure having a pore size in the range of 2 nm and 50 nm.

15. The internal hybrid electrochemical cell of claim 1 wherein said cathode further contains a resin binder that bonds graphene sheets and said discs, platelets, or sheets together.

16. The internal hybrid electrochemical cell of claim 1 wherein said cathode further contains a conductive filler selected from graphite or carbon particles, carbon black, expanded graphite, graphene, carbon nanotube, carbon nanofiber, carbon fiber, conductive polymer, or a combination thereof.

17. The internal hybrid electrochemical cell of claim 1, wherein at least one of the anode and the cathode contains a current collector that is a porous, electrically conductive material selected from metal foam, metal web or screen, perforated metal sheet, metal fiber mat, metal nanowire mat, porous conductive polymer film, conductive polymer nanofiber mat or paper, conductive polymer foam, carbon foam, carbon aerogel, carbon xerogel, graphene foam, graphene oxide foam, reduced graphene oxide foam, carbon fiber paper, graphene paper, graphene oxide paper, reduced graphene oxide paper, carbon nanofiber paper, carbon nanotube paper, or a combination thereof.

18. The internal hybrid electrochemical cell of claim 1, wherein said anode active material contains prelithiated particles of Si, Ge, SiO, Sn, SnO₂, or a combination thereof and said prelithiated particles reside in pores of a porous, electrically conductive material selected from metal foam, metal web or screen, perforated metal sheet, metal fiber mat, metal nanowire mat, porous conductive polymer film, conductive polymer nanofiber mat or paper, conductive polymer foam, carbon foam, carbon aerogel, carbon xerogel, graphene foam, graphene oxide foam, reduced graphene oxide foam, carbon fiber paper, graphene paper, graphene oxide paper, reduced graphene oxide paper, carbon nanofiber paper, carbon nanotube paper, or a combination thereof.

19. The internal hybrid electrochemical cell of claim 1, wherein a discharge operation of said cell involves both lithium intercalation into an interior of said cathode active material and lithium adsorption on surfaces of said cathode active material.

20. The internal hybrid electrochemical cell of claim 1, wherein the electrolyte is organic liquid electrolyte, ionic liquid electrolyte, or gel electrolyte containing an amount of lithium ions when said cell is made.

21. An energy storage device comprising at least two internal hybrid electrochemical cells of claim 1 connected in series or in parallel.

22. An energy device comprising at least one internal hybrid electrochemical cell of claim 1, which is electrically connected to an electrochemical cell in series or in parallel.
